(19) United States
(12) Patent Application Publication
(10) Pub. No.: US 2004/0009405 A1
(43) Pub. Date: Jan. 15, 2004

(54) Hologram media printing wheel

(76) Inventor: Cheng-Hsiu Chen, Jwu-Beei City (TW)

Correspondence Address: Keith Kline, PRO-TECHTOR INTERNATIONAL SERVICES, 20775 Norada Court, Saratoga, CA, 95070-3018, US

(21) Appl. No.: 10/192,572

(22) Filed: Jul. 9, 2002

(51) Int. Cl. G03H 1/02; G03H 1/04

(52) U.S. Cl. 430/1; 430/2; 359/8

(57) ABSTRACT

A hologram medium printing wheel includes a roller having an outer surface and an ultraviolet curable resin layer formed on the outer surface and completely surrounding the roller. Holographic patterns are formed on the resin layer before it is cured. The resin is then exposed to an ultraviolet source for curing and forms a solid printing mold. If desired, an adhesive layer can be interposed between the resin layer and the roller to more securely attach the resin layer to the roller.

### BACKGROUND OF THE INVENTION

1. Field of the Invention

The present invention relates generally to printing of holographic patterns on a medium to form a hologram medium, and in particular to a printing wheel for mass production of hologram media.

2. The Related Art

Media with holographic patterns printed thereon for formation of hologram media have been widely used in a variety of applications, such as packages and anti-counterfeit labels used in music and video discs and credit cards. The holograms are conventionally formed on a carrier medium, such as paper and plastic films, by a printing wheel for mass production. FIG. 9 of the attached drawings shows a conventional hologram medium printing wheel, designated with reference numeral A, in which a slit A1 is formed. A flexible hologram mold plate B1 is attached to a metal film B. The metal film B, together with the mold plate B1, has opposite edges that are then fit into the slit A1 to secure the mold plate B1 to the wheel A. A hologram medium, designated with reference numeral C as shown in FIG. 10, made by means of the printing wheel A has a blank strip X caused by the slit A1 of the wheel A. This makes the quality of the hologram medium poor. Further, the attachment of the hologram mold B1 to the wheel A by means of edges received in the slit A1 is not firm. Separation of the hologram mold B1 from the wheel A is often encountered.

FIGS. 11 and 12 of the attached drawings show another conventional hologram medium printing wheel A′. The wheel A′ forms a recess A1′ extending circumferentially a predetermined angle and forming a step like shoulder on opposite ends thereof. A flexible hologram mold plate B1 is attached to a metal film B and the metal film B has opposite ends overlapping the shoulders of the recess A1′. The metal film B is fixed to the shoulders of the recess A1′ by bolts A2′. Such a printing wheel A′ must be used in pair in a hologram medium printing machine for printing holographic patterns on a carrier medium C′, as shown in FIG. 12. Due to the recess A1′, each printing wheel A′ is only capable to print half of the medium C′ whereby a complete hologram media C′ must be printed twice by the two printing wheels A′. However, the twice-printing technique causes a problem of partial overlap of the printed patterns. As shown in FIG. 13, an overlapping D1 of the printed patterns is formed in middle of a printed medium D. Further, since the printing must be done twice, labor and material costs increase and the operation is complicated. Parts damage caused by the complicated arrangement of the device is another problem occurring in this device.

It is thus desired to provide a hologram medium printing wheel for overcoming the above problems.

### SUMMARY OF THE INVENTION

An object of the present invention is to provide a hologram medium printing wheel having a completely continuous surface whereby no blank area or patter-overlapping occurs in the printed medium.

Another object of the present invention is to provide a hologram medium printing wheel wherein the mold of holographic patterns is securely fixed to the wheel.

A further object of the present invention is to provide a hologram medium printing wheel wherein the hologram medium can be formed by a single printing thereby reducing costs of labor and material.

To achieve the above objects, in accordance with the present invention, there is provided a hologram medium printing wheel comprising a roller having an outer surface and an ultraviolet curable resin layer formed on the outer surface and completely surrounding the roller. Holographic patterns are formed on the resin layer before it is cured. The resin is then exposed to an ultraviolet source for curing and forms a solid printing mold. An adhesive layer can be additionally interposed between the resin layer and the roller to more securely attach the resin layer to the roller.

### BRIEF DESCRIPTION OF THE DRAWINGS

The present invention will be apparent to those skilled in the art by reading the following description of preferred embodiments thereof, with reference to the attached drawings, in which:

FIG. 1 is a cross-sectional view of a hologram medium printing wheel constructed in accordance with a first embodiment of the present invention;

FIG. 2 is a cross-sectional view showing an adhesive layer formed on a roller of the hologram medium printing wheel of the present invention;

FIG. 3 is a cross-sectional view showing an ultraviolet curable resin layer formed on the adhesive layer of the hologram medium printing wheel of the present invention;

FIG. 4 is a cross-sectional view showing a holographic pattern mold plate 40 is pressed onto the resin layer for forming holographic patterns on the resin layer, the resin layer being cured by exposure to ultraviolet source;

FIG. 5 is an enlarged view of encircled portion E of FIG. 4 showing peeling the mold plate 40 off the resin layer of the hologram medium printing wheel of the present invention;

FIG. 6 shows a hologram medium made by the hologram medium printing wheel shown in FIG. 1;

FIG. 7 a cross-sectional view of a hologram medium printing wheel constructed in accordance with a second embodiment of the present invention;

FIG. 8 shows a hologram medium made by the hologram medium printing wheel shown in FIG. 7;

FIG. 9 is a cross-sectional view of a conventional hologram medium printing wheel;

FIG. 10 shows a hologram medium made by the conventional hologram medium printing wheel shown in FIG. 9;

FIG. 11 shows a cross-sectional view of another conventional hologram medium printing wheel;

FIG. 12 is a schematic view of a conventional hologram medium printing machine comprising a pair of the conventional hologram medium printing wheels of FIG. 11; and

FIG. 13 shows a hologram medium made by the conventional hologram medium printing machine shown in FIG. 12.

### DETAILED DESCRIPTION OF THE PREFERRED EMBODIMENTS

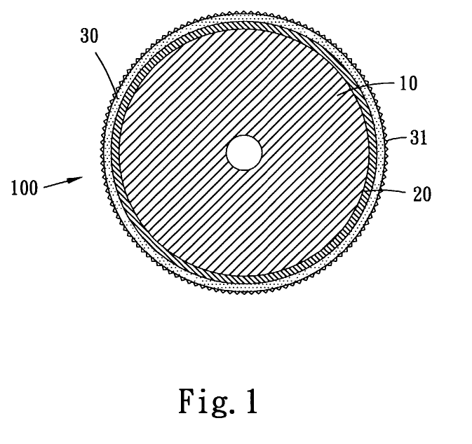

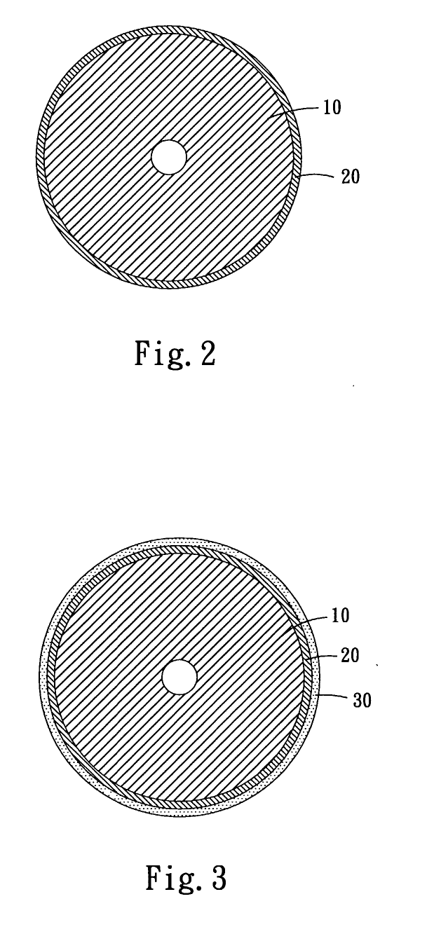

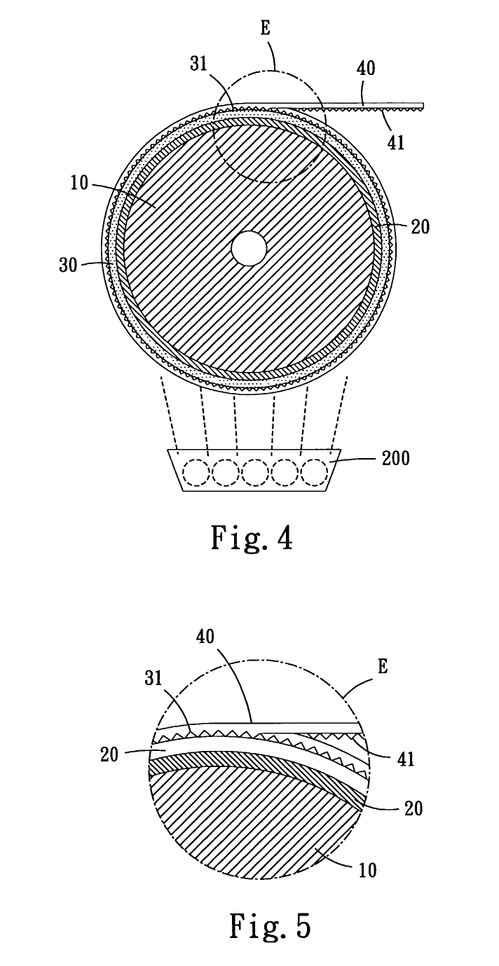

With reference to the drawings and in particular to FIGS. 1-3, a hologram medium printing wheel constructed in accordance with a first embodiment of the present invention, generally designated with reference numeral 100, comprises a roller 10 having a cylindrical outer surface (not labeled). The roller 10 is made of any suitable rigid material, such as metals and plastics. A layer 20 of adhesive is formed on the outer surface of the roller 10, as shown in FIG. 2. The adhesive is a resin based adhesive or other suitable adhesives. An outer resin layer 30 is formed around the adhesive layer 20, as shown in FIG. 3. The resin that makes the layer 30 is a ultraviolet curable resin in the embodiment illustrated. The resin layer 30 is securely attached to the roller 10 by means of the adhesive layer 20.

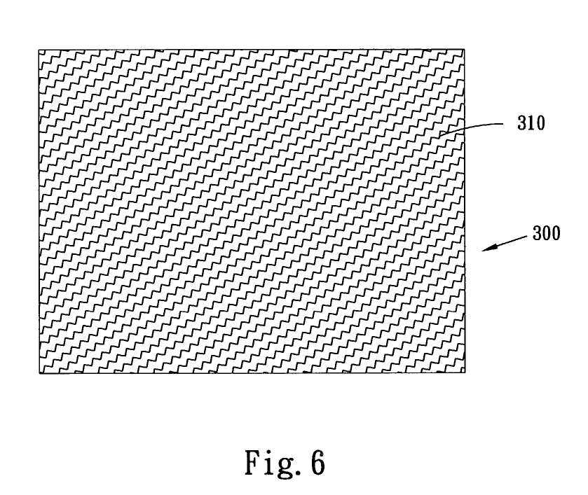

Also referring to FIGS. 4 and 5, in forming holographic patterns on the resin layer 30, a metal mold plate 40 having “negative” patterns 41 formed thereon is pressed onto the resin layer 30 whereby complementary, “positive” patterns 31 are formed on the surface of the resin layer 30. The wheel 100 is then exposed to an ultraviolet source 200 for curing the resin 30. The metal mold plate 40 is then peeled and removed from the resin layer 30 after the resin 30 is cured.

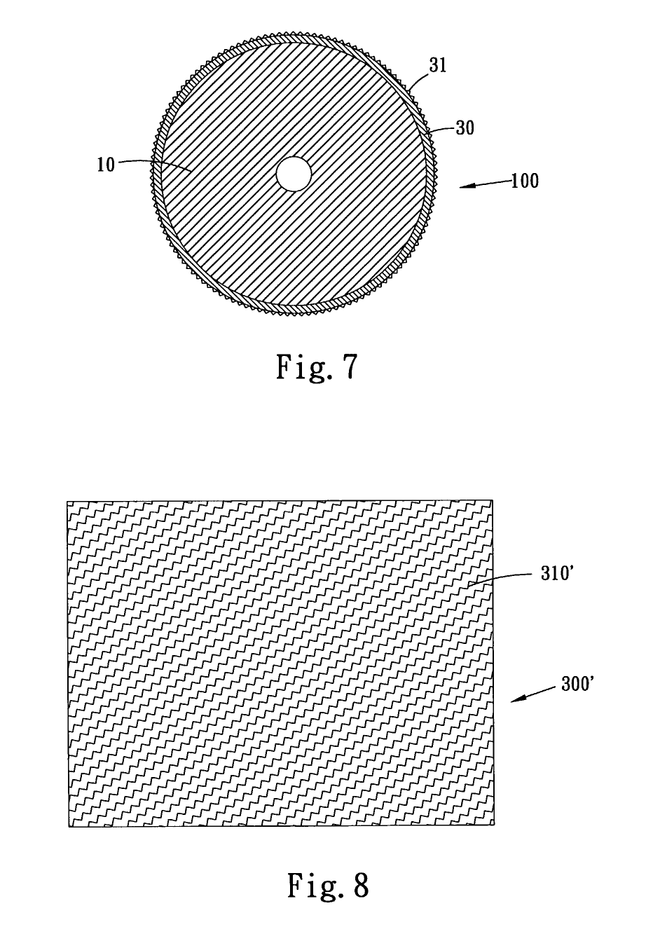

FIG. 6 shows a hologram medium, labeled 300, made by means of the hologram medium printing wheel 100 of the present invention. Since the patterns 31 of the layer 30 are formed completely around the outer surface of the roller 10, patterns 31 printed on the medium 300 is in perfect continuous form with no blank area or pattern-overlapping formed therein. Further, the adhesive layer 20 provides means for very securely attaching the resin layer 30 to the roller 10. Thus, separation of the resin layer 30 from the roller 10 is effectively eliminated. The quality of the printed hologram medium is significantly improved as compared with the conventional hologram medium printing wheels.

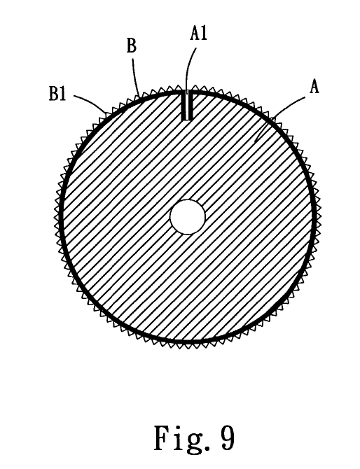

FIG. 7 shows a hologram medium printing wheel constructed in accordance with a second embodiment of the present invention, also designated with reference numeral 100 for simplicity. The hologram printing wheel 100 of the second embodiment shown in FIG. 7 is substantially identical to the hologram printing wheel 100 of the first embodiment discussed with reference to FIGS. 1-5, but the resin layer 30 of the second embodiment is directly attached to the outer surface of the roller 10. No adhesive layer is required in the hologram medium printing wheel of the second embodiment. The holographic patterns are formed on the resin layer 30 by means of the same way as shown in FIGS. 4 and 5 and thus no further discussion is needed herein.

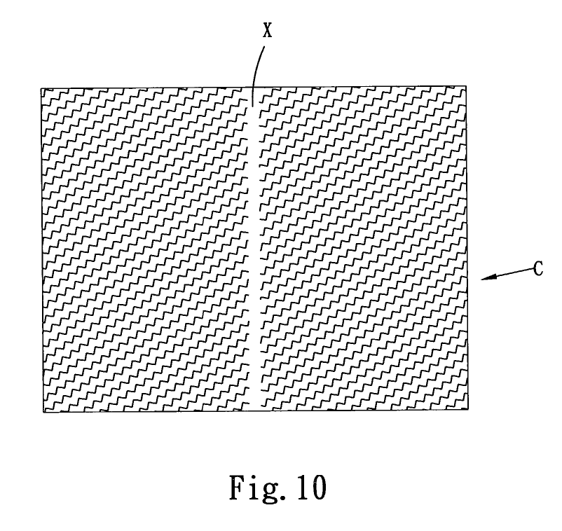

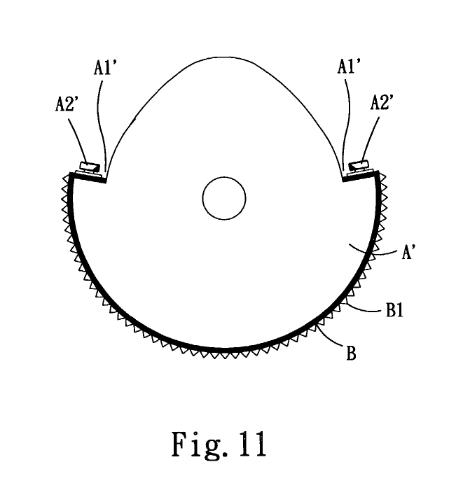

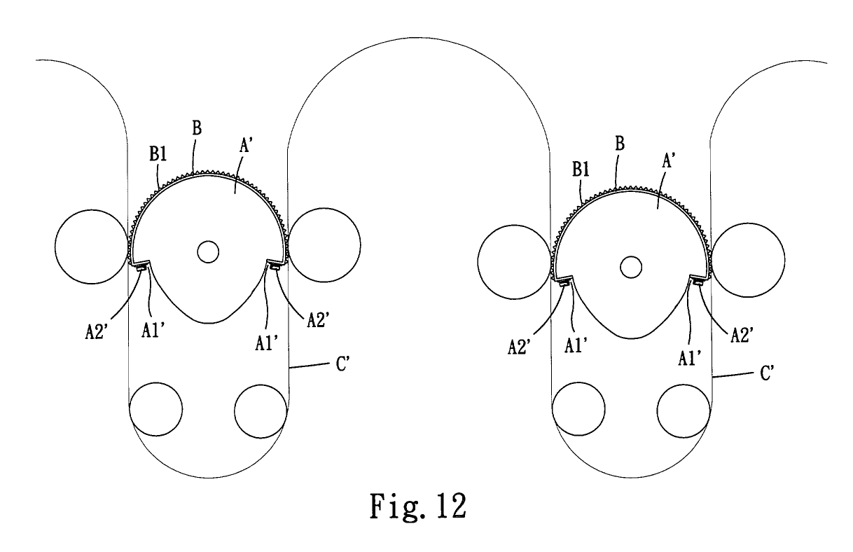

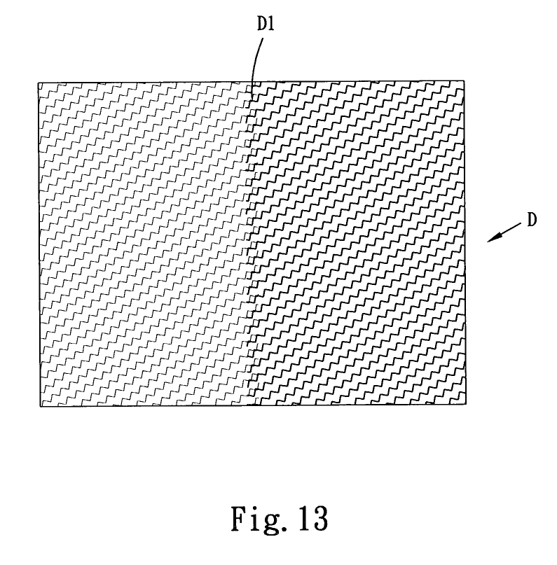

FIG. 8 shows a hologram medium, labeled 300′, made by means of the hologram medium printing wheel shown in FIG. 7. Similarly, perfectly continuous patterns 310′ are formed on the medium 300′ with no blank area or pattern-overlapping occurring thereon. The quality of the hologram medium is thus improved as compared to the conventional hologram media.

The present invention provides a hologram medium printing wheel having a simple but sound structure, which not only improves the quality of hologram media printed thereby but also effectively reduces costs for production of the hologram media. Industrial utilization of the hologram medium printing wheel of the present invention is quite obvious to those skilled in the arts.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hologram medium printing wheel comprising:
a roller having an outer surface;
a curable resin layer formed completely around the outer surface of the roller, holographic patterns being formed on the resin layer and the resin then cured to form a printing mold.

2. The hologram medium printing wheel as claimed in claim 1, wherein the roller is made of a rigid material.

3. The hologram medium printing wheel as claimed in claim 2, wherein the rigid material is metal.

4. The hologram medium printing wheel as claimed in claim 2, wherein the rigid material is plastics.

5. The hologram medium printing wheel as claimed in claim 1, wherein the curable resin is a ultraviolet curable resin.

6. The hologram medium printing wheel as claimed in claim 1 further comprising an adhesive layer interposed between the resin layer and the outer surface of the roller.

7. The hologram medium printing wheel as claimed in claim 6, wherein the adhesive is a resin based adhesive.
